(19) United States
(12) Patent Application Publication
(10) Pub. No.: US 2019/0325351 A1
(43) Pub. Date: Oct. 24, 2019

(54) MONITORING AND COMPARING FEATURES ACROSS ENVIRONMENTS

(71) Applicant: Microsoft Technology Licensing, LLC, Redmond, WA (US)

(72) Inventors: David J. Stein, Mountain View, CA (US); Ruoyang Wang, Palo Alto, CA (US); Ke Wu, Sunnyvale, CA (US); Bee-Chung Chen, San Jose, CA (US); Priyanka Gariba, San Mateo, CA (US)

(73) Assignee: Microsoft Technology Licensing, LLC, Redmond, WA (US)

(21) Appl. No.: 15/958,999

(22) Filed: Apr. 20, 2018

(51) Int. Cl. G06N 99/00; G06F 17/30

(52) U.S. Cl. CPC G06N 99/005; G06F 17/30876

(57) ABSTRACT

The disclosed embodiments provide a system for processing data. During operation, the system selects a set of entity keys associated with reference feature values used with one or more machine learning models, wherein the reference feature values are generated in a first environment. Next, the system matches the set of entity keys to feature values from a second environment. The system then compares the feature values and the reference feature values to assess a consistency of a feature across the first and second environments. Finally, the system outputs a result of the assessed consistency for use in managing the feature in the first and second environments.

### RELATED APPLICATIONS

The subject matter of this application is related to the subject matter in a co-pending non-provisional application entitled “Common Feature Protocol for Collaborative Machine Learning,” having Ser. No. 15/046,199 and filing date 17 Feb. 2016 (Attorney Docket No. LI-901891-US-NP).

The subject matter of this application is related to the subject matter in a co-pending non-provisional application entitled “Distribution-Level Feature Monitoring and Consistency Reporting,” having Ser. No. 15/844,861 and filing date 18 Dec. 2017 (Attorney Docket No. LI-902175-US-NP).

The subject matter of this application is also related to the subject matter in a co-pending non-provisional application entitled “Framework for Managing Features Across Environments,” having serial number TO BE ASSIGNED, and filing date TO BE ASSIGNED (Attorney Docket No. LI-902216-US-NP).

The subject matter of this application is also related to the subject matter in a co-pending non-provisional application filed on the same day as the instant application, entitled “Managing Derived and Multi-Entity Features Across Environments,” having serial number TO BE ASSIGNED, and filing date TO BE ASSIGNED (Attorney Docket No. LI-902217-US-NP).

### BACKGROUND

### Field

The disclosed embodiments relate to machine learning systems. More specifically, the disclosed embodiments relate to techniques for monitoring and comparing features in feature management frameworks.

### Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, business analytics may be used to assess past performance, guide business planning, and/or identify actions that may improve future performance.

To glean such insights, large data sets of features may be analyzed using regression models, artificial neural networks, support vector machines, decision trees, naïve Bayes classifiers, and/or other types of machine-learning models. The discovered information may then be used to guide decisions and/or perform actions related to the data. For example, the output of a machine-learning model may be used to guide marketing decisions, assess risk, detect fraud, predict behavior, and/or customize or optimize use of an application or website.

However, significant time, effort, and overhead may be spent on feature selection during creation and training of machine-learning models for analytics. For example, a data set for a machine-learning model may have thousands to millions of features, including features that are created from combinations of other features, while only a fraction of the features and/or combinations may be relevant and/or important to the machine-learning model. At the same time, training and/or execution of machine-learning models with large numbers of features typically require more memory, computational resources, and time than those of machine-learning models with smaller numbers of features. Excessively complex machine-learning models that utilize too many features may additionally be at risk for overfitting.

Additional overhead and complexity may be incurred during sharing and organizing of feature sets. For example, a set of features may be shared across projects, teams, or usage contexts by denormalizing and duplicating the features in separate feature repositories for offline and online execution environments. As a result, the duplicated features may occupy significant storage resources and require synchronization across the repositories. Each team that uses the features may further incur the overhead of manually identifying features that are relevant to the team's operation from a much larger list of features for all of the teams. The same features may further be identified and/or specified multiple times during different steps associated with creating, training, validating, and/or executing the same machine-learning model.

Consequently, creation and use of machine-learning models in analytics may be facilitated by mechanisms for improving the monitoring, management, sharing, propagation, and reuse of features among the machine-learning models.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a system for monitoring features across environments in accordance with the disclosed embodiments.

FIG. 4 shows a flowchart illustrating the processing of data in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

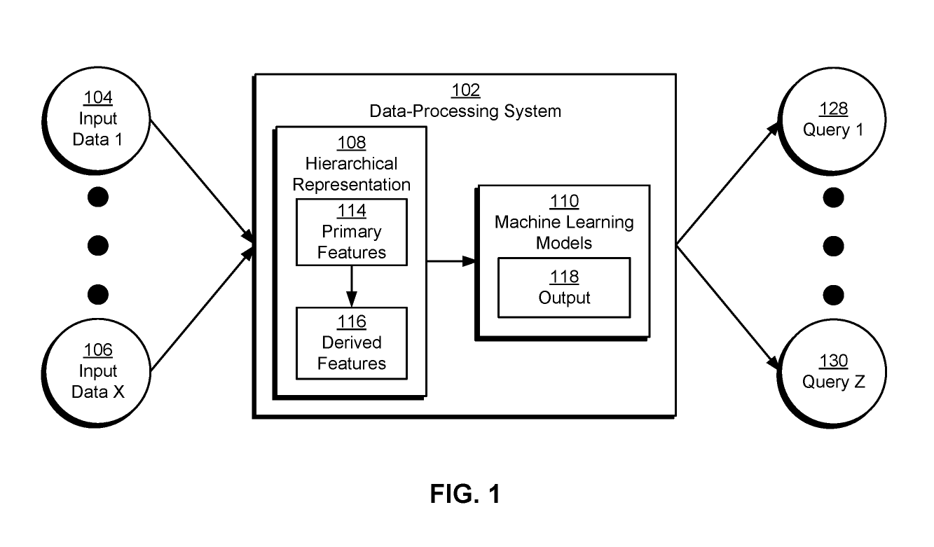

The disclosed embodiments provide a method, apparatus, and system for processing data. As shown in FIG. 1, the system includes a data-processing system 102 that analyzes one or more sets of input data (e.g., input data 1 104, input data x 106). For example, data-processing system 102 may create and train one or more machine learning models 110 for analyzing input data related to users, organizations, applications, job postings, purchases, electronic devices, websites, content, sensor measurements, and/or other categories. Machine learning models 110 may include, but are not limited to, regression models, artificial neural networks, support vector machines, decision trees, naïve Bayes classifiers, Bayesian networks, deep learning models, hierarchical models, and/or ensemble models.

In turn, the results of such analysis may be used to discover relationships, patterns, and/or trends in the data; gain insights from the input data; and/or guide decisions or actions related to the data. For example, data-processing system 102 may use machine learning models 110 to generate output 118 that includes scores, classifications, recommendations, estimates, predictions, and/or other properties. Output 118 may be inferred or extracted from primary features 114 in the input data and/or derived features 116 that are generated from primary features 114 and/or other derived features. For example, primary features 114 may include profile data, user activity, sensor data, and/or other data that is extracted directly from fields or records in the input data. The primary features 114 may be aggregated, scaled, combined, and/or otherwise transformed to produce derived features 116, which in turn may be further combined or transformed with one another and/or the primary features to generate additional derived features. After output 118 is generated from one or more sets of primary and/or derived features, output 118 is provided in responses to queries (e.g., query 1 128, query z 130) of data-processing system 102. In turn, the queried output 118 may improve revenue, interaction with the users and/or organizations, use of the applications and/or content, and/or other metrics associated with the input data.

In one or more embodiments, data-processing system 102 uses a hierarchical representation 108 of primary features 114 and derived features 116 to organize the sharing, production, and consumption of the features across different teams, execution environments, and/or projects. Hierarchical representation 108 may include a directed acyclic graph (DAG) that defines a set of namespaces for primary features 114 and derived features 116. The namespaces may disambiguate among features with similar names or definitions from different usage contexts or execution environments. Hierarchical representation 108 may include additional information that can be used to locate primary features 114 in different execution environments, calculate derived features 116 from the primary features and/or other derived features, and track the development of machine learning models 110 or applications that accept the derived features as input.

Consequently, data-processing system 102 may implement, in hierarchical representation 108, a common feature protocol that describes a feature set in a centralized and structured manner, which in turn can be used to coordinate large-scale and/or collaborative machine learning across multiple entities and machine learning models 110. Common feature protocols for large-scale collaborative machine learning are described in a co-pending non-provisional application entitled “Common Feature Protocol for Collaborative Machine Learning,” having Ser. No. 15/046,199, and filing date 17 Feb. 2016 (Attorney Docket No. LI-901891-US-NP), which is incorporated herein by reference.

In one or more embodiments, primary features 114 and/or derived features 116 are obtained and/or used with an online professional network, social network, or other community of users that is used by a set of entities to interact with one another in a professional, social, and/or business context. The entities may include users that use the online professional network to establish and maintain professional connections, list work and community experience, endorse and/or recommend one another, search and apply for jobs, and/or perform other actions. The entities may also include companies, employers, and/or recruiters that use the online professional network to list jobs, search for potential candidates, provide business-related updates to users, advertise, and/or take other action.

As a result, features 114 and/or derived features 116 may include member features, company features, and/or job features. The member features include attributes from the members' profiles with the online professional network, such as each member's title, skills, work experience, education, seniority, industry, location, and/or profile completeness. The member features also include each member's number of connections in the online professional network, the member's tenure on the online professional network, and/or other metrics related to the member's overall interaction or “footprint” in the online professional network. The member features further include attributes that are specific to one or more features of the online professional network, such as a classification of the member as a job seeker or non-job-seeker.

The member features may also characterize the activity of the members with the online professional network. For example, the member features may include an activity level of each member, which may be binary (e.g., dormant or active) or calculated by aggregating different types of activities into an overall activity count and/or a bucketized activity score. The member features may also include attributes (e.g., activity frequency, dormancy, total number of user actions, average number of user actions, etc.) related to specific types of social or online professional network activity, such as messaging activity (e.g., sending messages within the online professional network), publishing activity (e.g., publishing posts or articles in the online professional network), mobile activity (e.g., accessing the social network through a mobile device), job search activity (e.g., job searches, page views for job listings, job applications, etc.), and/or email activity (e.g., accessing the online professional network through email or email notifications).

The company features include attributes and/or metrics associated with companies. For example, company features for a company may include demographic attributes such as a location, an industry, an age, and/or a size (e.g., small business, medium/enterprise, global/large, number of employees, etc.) of the company. The company features may further include a measure of dispersion in the company, such as a number of unique regions (e.g., metropolitan areas, counties, cities, states, countries, etc.) to which the employees and/or members of the online professional network from the company belong.

A portion of company features may relate to behavior or spending with a number of products, such as recruiting, sales, marketing, advertising, and/or educational technology solutions offered by or through the online professional network. For example, the company features may also include recruitment-based features, such as the number of recruiters, a potential spending of the company with a recruiting solution, a number of hires over a recent period (e.g., the last 12 months), and/or the same number of hires divided by the total number of employees and/or members of the online professional network in the company. In turn, the recruitment-based features may be used to characterize and/or predict the company's behavior or preferences with respect to one or more variants of a recruiting solution offered through and/or within the online professional network.

The company features may also represent a company's level of engagement with and/or presence on the online professional network. For example, the company features may include a number of employees who are members of the online professional network, a number of employees at a certain level of seniority (e.g., entry level, mid-level, manager level, senior level, etc.) who are members of the online professional network, and/or a number of employees with certain roles (e.g., engineer, manager, sales, marketing, recruiting, executive, etc.) who are members of the online professional network. The company features may also include the number of online professional network members at the company with connections to employees of the online professional network, the number of connections among employees in the company, and/or the number of followers of the company in the online professional network. The company features may further track visits to the online professional network from employees of the company, such as the number of employees at the company who have visited the online professional network over a recent period (e.g., the last 30 days) and/or the same number of visitors divided by the total number of online professional network members at the company.

One or more company features may additionally be derived features 116 that are generated from member features. For example, the company features may include measures of aggregated member activity for specific activity types (e.g., profile views, page views, jobs, searches, purchases, endorsements, messaging, content views, invitations, connections, recommendations, advertisements, etc.), member segments (e.g., groups of members that share one or more common attributes, such as members in the same location and/or industry), and companies. In turn, the company features may be used to glean company-level insights or trends from member-level online professional network data, perform statistical inference at the company and/or member segment level, and/or guide decisions related to business-to-business (B2B) marketing or sales activities.

The job features describe and/or relate to job listings and/or job recommendations within the online professional network. For example, the job features may include declared or inferred attributes of a job, such as the job's title, industry, seniority, desired skill and experience, salary range, and/or location. One or more job features may also be derived features 116 that are generated from member features and/or company features. For example, the job features may provide a context of each member's impression of a job listing or job description. The context may include a time and location (e.g., geographic location, application, website, web page, etc.) at which the job listing or description is viewed by the member. In another example, some job features may be calculated as cross products, cosine similarities, statistics, and/or other combinations, aggregations, scaling, and/or transformations of member features, company features, and/or other job features.

Those skilled in the art will appreciate that primary features 114 and/or derived features 116 may be obtained from multiple data sources, which in turn may be distributed across different environments. For example, the features may be obtained from data sources in online, offline, nearline, streaming, and/or search-based execution environments. In addition, each data source and/or environment may have a separate application-programming interface (API) for retrieving and/or transforming the corresponding features. Consequently, managing, sharing, obtaining, and/or calculating features across the environments may require significant overhead and/or customization to specific environments and/or data sources.

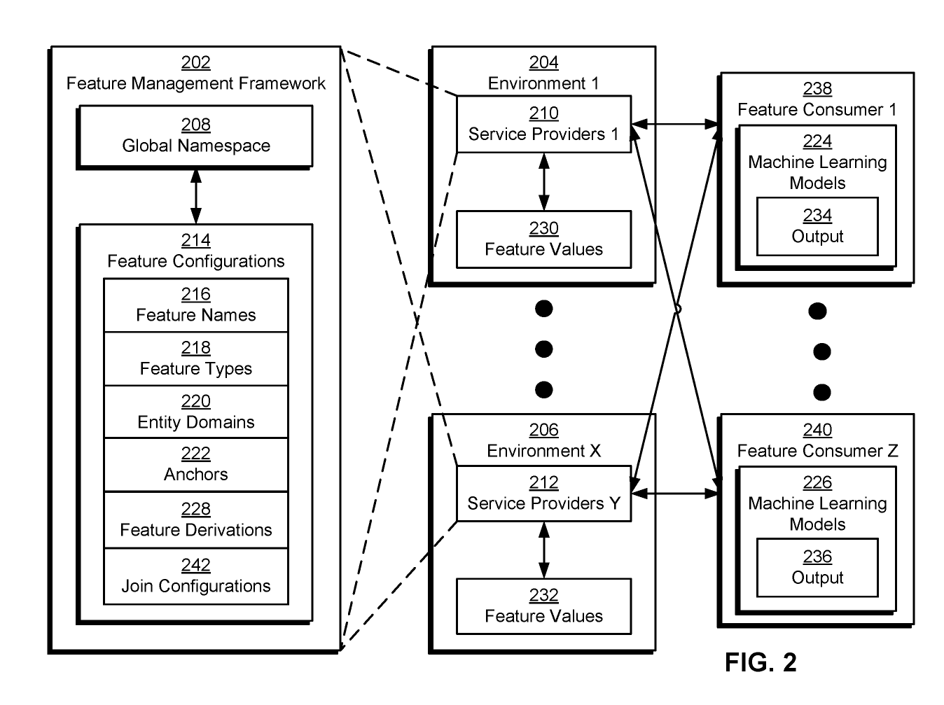

In one or more embodiments, data-processing system 102 includes functionality to perform centralized feature management in a way that is decoupled from environments, systems, and/or use cases of the features. As shown in FIG. 2, a system for processing data (e.g., data-processing system 102 of FIG. 1) includes a feature management framework 202 that executes in and/or is deployed across a number of service providers (e.g., service providers 1 210, service providers y 212) in different environments (e.g., environment 1 204, environment x 206).

The environments include different execution contexts and/or groups of hardware and/or software resources in which feature values 230-232 of the features can be obtained or calculated. For example, the environments may include an online environment that provides real-time feature values, a nearline or streaming environment that emits events containing near-realtime records of updated feature values, an offline environment that calculates feature values on a periodic and/or batch-processing basis, and/or a search-based environment that performs fast reads of databases and/or other data stores in response to queries for data in the data stores.

One or more environments may additionally be contained or nested in one or more other environments. For example, an online environment may include a “remix” environment that contains a library framework for executing one or more applications and/or generating additional features.

The service providers may include applications, processes, jobs, services, and/or modules for generating and/or retrieving feature values 230-232 for use by a number of feature consumers (e.g., feature consumer 1 238, feature consumer z 240). The feature consumers may use one or more sets of feature values 230-232 as input to one or more machine learning models 224-226 during training, testing, and/or validation of machine learning models 224-226 and/or scoring using machine learning models 224-226. In turn, output 234-236 generated by machine learning models 224-226 from the sets of feature values 230-232 may be used by the feature consumers and/or other components to adjust parameters and/or hyperparameters of machine-learning models 224-226; verify the performance of machine-learning models 224-226; select versions of machine-learning models 224-226 for use in production or real-world settings; and/or make inferences, recommendations, predictions, and/or estimates related to feature values 230-232 within the production or real-world settings.

In one or more embodiments, the service providers use components of feature management framework 202 to generate and/or retrieve feature values 230-232 of features from the environments in a way that is decoupled from the locations of the features and/or operations or computations used to generate or retrieve the corresponding feature values 230-232 within the environments. First, the service providers organize the features within a global namespace 208 that spans the environments. Global namespace 208 may include a hierarchical representation of feature names 216 and use scoping relationships in the hierarchical representation to disambiguate among features with common or similar names, as described in the above-referenced application. Consequently, global namespace 208 may replace references to locations of the features (e.g., filesystem paths, network locations, streams, tables, fields, services, etc.) with higher-level abstractions for identifying and accessing the features.

Second, the service providers use feature configurations 214 in feature management framework 202 to define, identify, locate, retrieve, and/or calculate features from the respective environments. Each feature configuration includes metadata and/or information related to one or more features in global namespace 208. Individual feature configurations 214 can be independently created and/or updated by a user, team, and/or entity without requiring knowledge of feature configurations 214 for other features and/or from other users, teams, and/or entities.

Feature configurations 214 include feature names 216, feature types 218, entity domains 220, anchors 222, feature derivations 228, and join configurations 242 associated with the features. Feature names 216 include globally scoped identifiers for the features, as obtained from and/or maintained using global namespace 208. For example, a feature representing the title in a member's profile with a social network or online professional network may have a globally namespaced feature name of “org.member.profile.title.” The feature name may allow the feature to be distinguished from a different feature for a title in a job listing, which may have a globally namespaced feature name of “org.job.title.”

Feature types 218 include semantic types that describe how the features can be used with machine learning models 224-226. For example, each feature may be assigned a feature type that is numeric, binary, categorical, categorical set, categorical bag, and/or vector. The numeric type represents numeric values such as real numbers, integers, and/or natural numbers. The numeric type may be used with features such as numeric identifiers, metrics (e.g., page views, messages, login attempts, user sessions, click-through rates, conversion rates, spending amounts, etc.), statistics (e.g., mean, median, maximum, minimum, mode, percentile, etc.), scores (e.g., connection scores, reputation scores, propensity scores, etc.), and/or other types of numeric data or measurements.

The binary feature type includes Boolean values of 1 and 0 that indicate if a corresponding attribute is true or false. For example, binary features may specify a state of a member (e.g., active or inactive) and/or whether a condition has or has not been met.

Categorical, categorical set, and categorical bag feature types include fixed and/or limited names, labels, and/or other qualitative attributes. For example, a categorical feature may represent a single instance of a color (e.g., red, blue, yellow, green, etc.), a type of fruit (e.g., orange, apple, banana, etc.), a blood type (e.g., A, B, AB, O, etc.), and/or a breed of dog (e.g., collie, shepherd, terrier, etc.). A categorical set may include one or more unique values of a given categorical feature, such as {apple, banana, orange} for the types of fruit found in a given collection. A categorical bag may include counts of the values, such as {banana: 2, orange: 3} for a collection of five pieces of fruit and/or a bag of words from a sentence or text document.

The vector feature type represents an array of features, with each dimension or element of the array corresponding to a different feature. For example, a feature vector may include an array of metrics and/or scores for characterizing a member of a social network. In turn, a metric such as Euclidean distance or cosine similarity may be calculated from feature vectors of two members to measure the similarity, affinity, and/or compatibility of the members.

Entity domains 220 identify classes of entities described by the features. For example, entity domains 220 for features related to a social network or online professional network may include members, jobs, groups, companies, products, business units, advertising campaigns, and/or experiments. Entity domains 220 may be encoded and/or identified within global namespace 208 (e.g., “jobs.title” versus “member.title” for features related to professional titles) and/or specified separately from global namespace 208 (e.g., “feature1.entitydomain=members”). One or more features may additionally have compound entity domains 220. For example, an interaction feature between members and jobs may have an entity domain of {members, jobs}.

Anchors 222 include metadata that describes how to access the features in specific environments. For example, anchors 222 may include locations or paths of the features in the environments; classes, functions, methods, calls, and/or other mechanisms for accessing data related to the features; and/or formulas or operations for calculating and/or generating the features from the data.

A service provider may use an anchor for accessing a feature in the service provider's environment to retrieve and/or calculate one or more feature values (e.g., feature values 230-232) for the feature and provide the feature values to a feature consumer. For example, the service provider may receive, from a feature consumer, a request for obtaining feature values of one or more features from the service provider's environment. The service provider may match feature names in the request to one or more anchors 222 for the corresponding features and use the anchors and one or more entity keys (e.g., member keys, job keys, company keys, etc.) in the request to obtain feature values for the corresponding entities from the environment. The service provider may optionally format the feature values according to parameters in the request and return the feature values to the feature consumer for use in training, testing, validating, and/or executing machine learning models (e.g., machine learning models 224-226) associated with the feature consumer.

Join configurations 242 include metadata that is used to join feature values for one or more features with observation data associated with the feature values. Each join configuration may identify the features and observation data and include one or more join keys that are used by the service provider to perform join operations. In turn, a service provider may use a join configuration to generate data that is used in training, testing, and/or validation of a machine learning model. Using anchors and join configurations to access features in various environments is described in a co-pending non-provisional application filed on the same day as the instant application, entitled “Framework for Managing Features Across Environments,” having serial number TO BE ASSIGNED, and filing date TO BE ASSIGNED (Attorney Docket No. LI-902216-US-NP), which is incorporated herein by reference.

Feature derivations 228 include metadata for calculating or generating derived features (e.g., derived features 116 of FIG. 1) from other “input” features, such as primary features with anchors 222 in the respective environments and/or other derived features. For example, feature derivations 228 may include expressions, operations, and/or references to code for generating or calculating the derived features from other features. Like anchors 222, feature derivations 228 may identify features by globally namespaced feature names 216 and/or be associated with specific environments. For example, a feature derivation may specify one or more input features used to calculate a derived feature and/or one or more environments in which the input features can be accessed.

In turn, a service provider uses feature derivations 228 to verify the reachability of a derived feature in the service provider's environment, generate a dependency graph of features used to produce the derived feature, verify a compatibility of the derived feature with input features used to generate the derived feature, and obtain and/or calculate features in the dependency graph according to the determined evaluation order. Using feature derivations to generate derived features across environments is described in a co-pending non-provisional application filed on the same day as the instant application, entitled “Managing Derived and Multi-Entity Features Across Environments,” having serial number TO BE ASSIGNED, and filing date TO BE ASSIGNED (Attorney Docket No. LI-902217-US-NP), which is incorporated herein by reference.

In one or more embodiments, feature management framework 202, individual service providers that implement feature management framework 202, and/or other components of the system include functionality to perform monitoring and comparison of feature values 230-232 across environments. In addition, such monitoring and comparison may be done in a way that avoids sampling bias in the feature values, as described in further detail below.

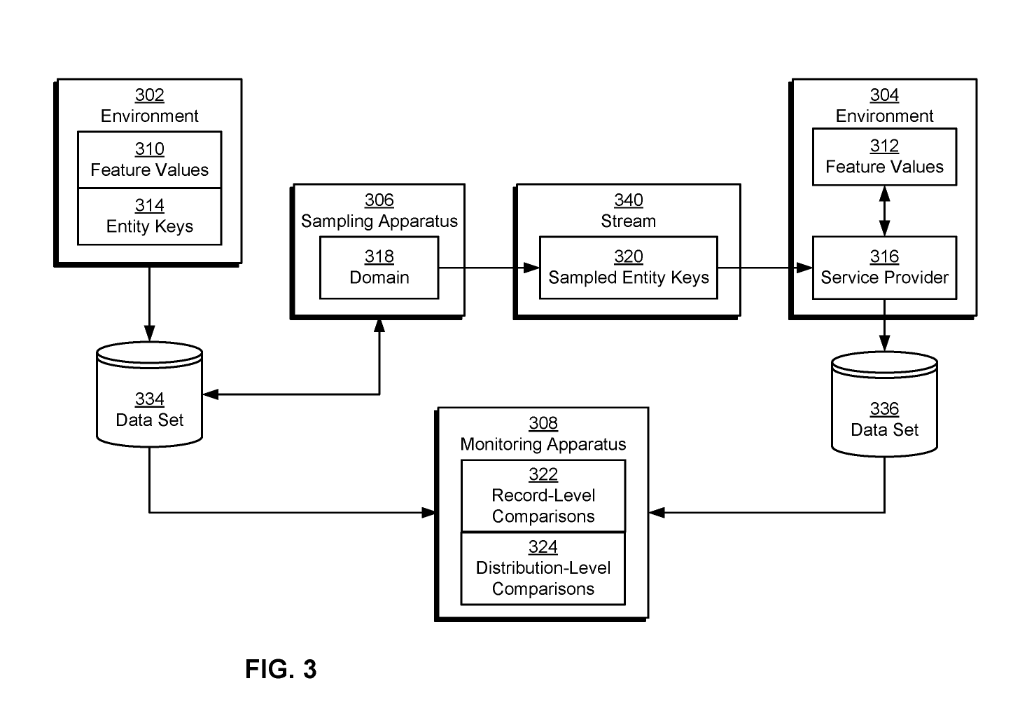

FIG. 3 shows a system for monitoring features across environments 302-304 in accordance with the disclosed embodiments. As shown in FIG. 3, the system includes a sampling apparatus 306 and a monitoring apparatus 308. Each of these components is described in further detail below.

As described above, environments 302-304 may include different execution contexts and/or sets of resources in which feature values 310-312 of features can be obtained or calculated. For example, environment 302 may be an offline environment that generates feature values 310 on a periodic (e.g., hourly, daily, weekly, etc.) and/or batch-processing basis, and environment 304 may be a nearline or online environment that generates feature values 312 on a real-time and/or nearline basis (e.g., while a user interacts with an application).

In addition, a given feature may be generated in both environments 302-304. For example, a score representing a user's likelihood of performing an action (e.g., clicking, viewing, purchasing, etc.) may be generated by an offline environment on a daily basis and/or by an online environment as the user interacts with an application. As a result, feature values 310-312 of the feature may be monitored and/or compared to ensure that the feature is generated consistently across environments 302-304 and/or to detect distribution-level drift in the feature between environments 302-304. Such monitoring and/or comparison may further be performed in a way that avoids sampling bias in one or both sets of feature values 310-312.

First, sampling apparatus 306 uses a domain 318 of the feature to select a set of sampled entity keys 320 associated with feature values 310 of the feature from environment 302. For example, domain 318 may include an entity domain of entity keys 314, such as members, jobs, groups, companies, products, business units, advertising campaigns, and/or experiments identified using entity keys 314. As a result, domain 318 may allow sampling apparatus 306 to determine the range of values encompassed by entity keys 314, the distribution of entity keys 314 in feature values 310, and/or other attributes of entity keys 314 with respect to feature values 310.

More specifically, sampling apparatus 306 may use domain 318 and/or entity keys 314 to generate a random sample of entity keys 314 from a data set 334 containing feature values 310 and/or entity keys 314. For example, environment 302 may be an offline environment that generates feature values 310 for all or almost all entity keys 314 on a periodic basis. After a batch of feature values 310 is produced, the offline environment may store the batch of features values 310 with the corresponding entity keys 314 in data set 334 within an offline data store. In turn, sampling apparatus 306 may randomly select a subset of entity keys 314 from data store 334 based on the range of values encompassed by entity keys 314. In another example, sampling apparatus 306 may generate sampled entity keys 320 in a way that reflects the distribution of entity keys 314 in a set of feature values 310 generated within environment 302. In a third example, sampling apparatus 306 may include all entity keys 314 associated with the set of feature values 310 in sampled entity keys 320 (e.g., if the set of entity keys 314 is relatively small).

After sampled entity keys 320 are generated, sampling apparatus 306 transmits sampled entity keys 320 in a stream 340 for use by other components of the system. For example, sampling apparatus 306 may generate a stream of messages containing sampled entity keys 320 within a distributed streaming platform such as Apache Kafka (Kafka™ is a registered trademark of the Apache Software Foundation).

In turn, a service provider 316 in a different environment 304 obtains sampled entity keys 320 from stream 340 and matches sampled entity keys 320 to a corresponding set of feature values 312 from environment 304. For example, service provider 316 may use an anchor, feature derivation, and/or other metadata for accessing feature values 312 in environment 304 to retrieve feature values 312 associated with sampled entity keys 320 from environment 304.

Service provider 316 then stores feature values 312 with the corresponding sampled entity keys 320 in another data set 336. For example, service provider 316 may store feature values 312 generated in an online or nearline environment 304 in the same data store as data set 334 or in a different data store than that of data set 334.

After data sets 334-336 containing feature values 310-312 for sampled entity keys 320 are generated, monitoring apparatus 308 performs one or more comparisons of data sets 334-336 to assess the consistency of the feature across environments 302-304. Such comparisons may include record-level comparisons 322 and/or distribution-level comparisons 324 of feature values 310-312 in data sets 334-336.

First, monitoring apparatus 308 uses sampled entity keys 320 to perform record-level comparisons 322 of data sets 334-336. During record-level comparisons 322, monitoring apparatus 308 may use each entity key in sampled entity keys 320 to obtain a first record containing a feature value for the corresponding entity from data set 334 and a second record containing another feature value for the entity from data set 336. Monitoring apparatus 308 may then compare feature values in the records to determine if the feature is consistently generated across environments 302-304 and/or detect any differences in the feature values between environments 302-304. For example, monitoring apparatus 308 may determine if the feature values in the records exactly match one another, are correlated with one another, differ by less than a threshold amount, and/or have the same formatting or feature type.

Monitoring apparatus 308 may also, or instead, perform distribution-level comparisons 324 of data sets 334-336. During distribution-level comparison 324, monitoring apparatus 308 may apply a hypothesis test to feature values 310-312 in data sets 334-336 to determine a distribution-level consistency in the feature across environments 302-304. The hypothesis test may produce a test statistic from feature values 310-312; when the test statistic indicates a statistically significant difference between distributions of feature values 310-312 in data sets 334-336, a lack of distribution-level consistency in data sets 334-336 may be found. Distribution-level comparison of feature values in data sets is described in a co-pending non-provisional application entitled “Distribution-Level Feature Monitoring and Consistency Reporting,” having Ser. No. 15/844,861 and filing date 18 Dec. 2017 (Attorney Docket No. LI-902175-US-NP), which is incorporated herein by reference.

Monitoring apparatus 308 and/or another component of the system may additionally handle missing feature values 310-312 in one or both data sets 334-336 in a way that allows subsequent record-level comparisons 322 and/or distribution-level comparisons 324 of data sets 334-336. For example, an entity key that lacks a feature value in one or both data sets 334-336 may be assigned a default value (e.g., 0 for a numeric feature) and/or a “missing” value. In turn, the assigned value may allow record-level comparisons 322 and/or distribution-level comparisons 324 to be defined and/or performed using the entity key instead of omitting the entity key from record-level comparisons 322 and/or distribution-level comparisons 324.

After record-level comparisons 322 and/or distribution-level comparisons 324 of data sets 334-336 are performed, monitoring apparatus 308 may output one or more results of the comparison. For example, monitoring apparatus 308 may include the result in a visualization, table, spreadsheet, alert, message, notification, log, and/or other mechanism for storing, outputting, or transmitting data. When record-level comparisons 322 are made, the result may identify a proportion of sampled entity keys 320 with matching feature values in both data sets 334-336 and/or a proportion of sampled entity keys 320 with feature values that are similar (e.g., within a certain range of one another, adhering to a common format, having the same feature type, etc.).

When distribution-level comparisons 324 are made, the result may include values of a test statistic, statistical significance, and/or p-value associated with a hypothesis test that is applied to data sets 334-336. The result may also include a subset of feature values 310-312 that contribute to a lack of distribution-level consistency in the feature, such as one or more histogram bins that contribute most to a deviation in the distribution of the feature across data sets 334-336.

The result may also include statistics associated with record-level comparisons 322, distribution-level comparisons 324, and/or other types of comparisons of feature values 310-312. For example, the result may include a correlation coefficient between feature values 310-312 in data sets 334-336 and/or summary statistics (e.g., mean, variance, percentile, count, sum, etc.) associated with distributions of feature values 310-312 in each data set or the distribution of differences in feature values 310-312 across data sets 334-336.

Because data sets 334-336 include feature values 310-312 for the same set of randomly sampled entity keys 320, sampling bias associated with generation of feature values 310-312 in one or both environments 302-304 may be avoided. In particular, use of the same set of sampled entity keys 320 to generate data sets 334-336 containing feature values 310-312 from different environments may allow feature values 310-312 to be compared on a record-level basis. At the same time, data sets 334-336 that contain feature values 310-312 for the same sampled entity keys 320 may allow distribution-level comparisons 324 to be performed more accurately than if data sets 334-336 were generated from different sets of entity keys (e.g., one set of entity keys sampled from feature values for all users and another set of entity keys sampled from feature values for active users of an application). Consequently, the system of FIG. 3 may improve the performance and use of statistical models, feature-monitoring technologies, and feature management frameworks, along with applications, distributed systems, computer systems, and/or other platforms that use or leverage statistical models and/or features.

Those skilled in the art will appreciate that the system of FIG. 3 may be implemented in a variety of ways. First, sampling apparatus 306, monitoring apparatus 308, and/or data stores 334-336 may be provided by a single physical machine, multiple computer systems, one or more virtual machines, a grid, one or more databases, one or more filesystems, and/or a cloud computing system. Sampling apparatus 306 and monitoring apparatus 308 may additionally be implemented together and/or separately by one or more hardware and/or software components and/or layers. Moreover, various components of the system may be configured to execute in an offline, online, and/or nearline basis to perform different types of processing related to management and monitoring of features and feature sets.

Second, sampling apparatus 306, monitoring apparatus 308, and/or other components of the system may be implemented using service providers and/or feature management framework 202 of FIG. 2. Conversely, one or more components of the system may execute separately from components of the feature management framework and/or interact with the feature management framework to implement the functionality of the system.

Third, feature values 310-312, entity keys 314, sampled entity keys 320, and/or other data used by the system may be stored, defined, and/or transmitted using a number of techniques. For example, the system may be configured to retrieve and/or store feature values 310-312 and/or data sets 334-336 using different types of repositories, including relational databases, graph databases, data warehouses, filesystems, and/or flat files. In another example, the system may obtain and/or transmit feature values 310-312, entity keys 314, sampled entity keys 320, and/or data sets 334-336 in a number of formats, including database records, property lists, Extensible Markup Language (XML) documents, JavaScript Object Notation (JSON) objects, and/or other types of structured data. In a third example, sampling apparatus 306 and/or monitoring apparatus 308 may use various application-programming interfaces (APIs) and/or communications mechanisms to transmit and/or output sampled entity keys 320, results of record-level comparisons 322 and/or distribution-level comparisons 324, and/or other data used to monitor and/or compare feature values 310-312 in environments 302-304.

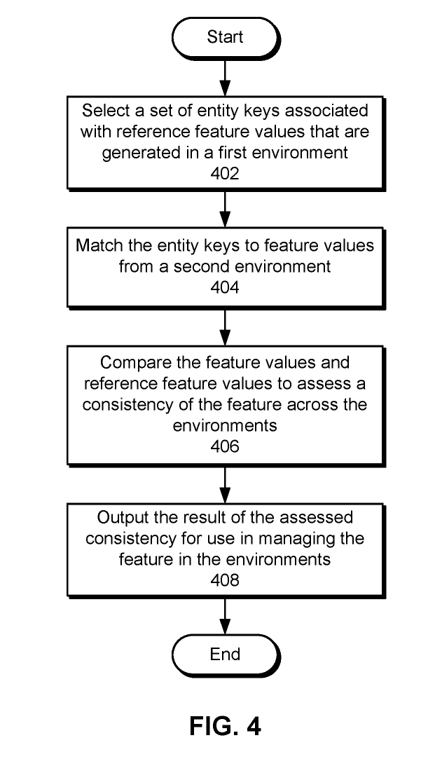

FIG. 4 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

The process begins with selecting a set of entity keys associated with reference feature values that are generated in a first environment (operation 402). For example, the reference feature values may be generated in an offline environment for all or almost all entity keys associated with a given feature. As a result, the set of entity keys may be randomly sampled from a data set containing the reference feature values.

The entity keys may additionally be obtained and/or selected based on an entity domain associated with the entity keys. For example, the entity domain may represent members, companies, jobs, and/or locations associated with use of an online professional network. Because the entity domain includes a known range of entity key values and/or a distribution of entity key values, the set of entity keys may be selected and/or sampled in a way that reflects the range and/or distribution of entity key values.

Next, the entity keys are matched to feature values from a second environment (operation 404). For example, the entity keys may be received in a stream of messages from a distributed streaming platform and/or another type of stream-processing platform. The entity keys may then be used with an anchor and/or feature derivation containing metadata for accessing the feature in the second environment to retrieve the feature values from the second environment and store the feature values in a data set.

The feature values and reference feature values are then compared to assess a consistency of the feature across the environments (operation 406). For example, the feature values and reference feature values may be obtained from different data sets in the same data store and/or different data stores, and each entity key in the sampled set of entity keys may be used to retrieve a corresponding record from each data set. Feature values in the records may then be compared for equality, similarity, formatting, and/or another attribute. In another example, a hypothesis test may be applied to the feature values and the reference feature values to determine a distribution-level consistency in the feature.

Finally, the result of the assessed consistency is outputted for use in managing the feature in the environments (operation 408). For example, the result may include a proportion of entity keys with matching feature values and/or similar feature values in both environments. In another example, the result may include a measure of distribution-level consistency between the feature values and reference feature values and/or a subset of feature values that contribute to a lack of distribution-consistency in the feature. In a third example, the result may include summary statistics associated with the reference feature values, feature values, and/or differences between the reference feature values and feature values.

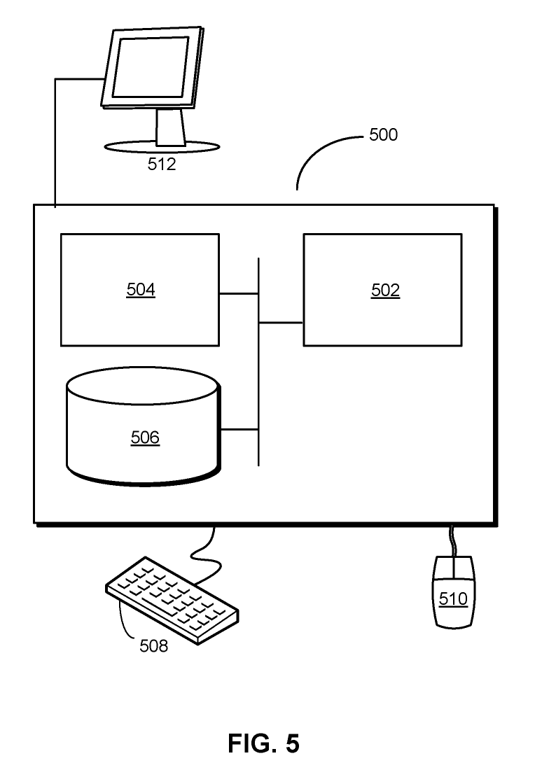

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system may include a sampling apparatus and a monitoring apparatus, one or more of which may alternatively be termed or implemented as a module, mechanism, or other type of system component. The sampling apparatus may identify a set of entity keys associated with reference feature values that are generated in a first environment. Next, the sampling apparatus and/or another component (e.g., a service provider) may match the set of entity keys to feature values from a second environment. The monitoring apparatus then compares the feature values and the reference feature values to assess a consistency of a feature across the first and second environments. Finally, the monitoring apparatus outputs a result of the assessed consistency for use in managing the feature in the first and second environments.

In addition, one or more components of computer system 500 may be remotely located and connected to the other components over a network. Portions of the present embodiments (e.g., sampling apparatus, monitoring apparatus, feature management framework, service providers, environments, etc.) may also be located on different nodes of a distributed system that implements the embodiments. For example, the present embodiments may be implemented using a cloud computing system that performs monitoring and comparing of feature values in a set of remote environments.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
selecting, by one or more computer systems, a set of entity keys associated with reference feature values used with a machine learning model, wherein the reference feature values are generated in a first environment;
matching, by the one or more computer systems, the set of entity keys to feature values from a second environment;
comparing the feature values and the reference feature values to assess a consistency of a feature across the first and second environments; and
outputting a result of the assessed consistency for use in managing the feature in the first and second environments.

2. The method of claim 1, wherein selecting the set of entity keys associated with the reference feature values comprises:
sampling the set of entity keys from a data set comprising the reference feature values.

3. The method of claim 2, wherein sampling the set of entity keys from the data set comprises:
selecting the set of entity keys based on an entity domain associated with the entity keys.

4. The method of claim 3, wherein the entity domain is associated with at least one of:
a member;
a company;
a job; and
a location.

5. The method of claim 2, wherein selecting the set of entity keys associated with the reference feature values further comprises:
transmitting the set of entity keys in a stream of messages.

6. The method of claim 1, wherein matching the set of entity keys to values of the feature from the second environment further comprises:
obtaining an anchor comprising metadata for accessing the feature in the second environment; and
using the anchor and the set of entity keys to retrieve the feature values of the feature from the second environment.

7. The method of claim 1, wherein comparing the values and the reference feature values comprises:
obtaining a first data set comprising the feature values;
obtaining a second data set comprising the reference feature values; and
applying a comparison to records in the first and second data sets.

8. The method of claim 7, wherein applying the comparison to the first and second data sets comprises:
for each entity key in the set of entity keys, using the entity key to obtain a first record in the first data set and a second record in the second data set; and
comparing a reference feature value of the feature from the first record and a feature value of the feature from the second record.

9. The method of claim 1, wherein the result comprises at least one of:
a first proportion of entity keys with matching feature values in the first and second environments; and
a second proportion of entity keys with similar feature values in the first and second environments.

10. The method of claim 1, wherein comparing the feature values and the reference feature values comprises:
applying a hypothesis test to the feature values and the reference feature values to determine a distribution-level consistency in the feature.

11. The method of claim 10, wherein the result comprises a subset of the feature values that contribute to a lack of the distribution-level consistency in the feature.

12. The method of claim 1, wherein:
the first environment comprises an offline environment; and
the second environment comprises an online environment.

13. A system, comprising:
one or more processors; and
memory storing instructions that, when executed by the one or more processors, cause the system to:
select a set of entity keys associated with reference feature values used with one or more machine learning models, wherein the reference feature values are generated in a first environment;
match the set of entity keys to feature values from a second environment;
compare the feature values and the reference feature values to assess a consistency of a feature across the first and second environments; and
output a result of the assessed consistency for use in managing the feature in the first and second environments.

14. The system of claim 13, wherein selecting the set of entity keys associated with the reference feature values comprises:
sampling the set of entity keys from a data set comprising the reference feature values.

15. The system of claim 13, wherein matching the set of entity keys to values of the feature from the second environment further comprises:
obtaining an anchor comprising metadata for accessing the feature in the second environment; and
using the anchor and the set of entity keys to retrieve the feature values of the feature from the second environment.

16. The system of claim 13, wherein comparing the values and the reference feature values comprises:
obtaining a first data set comprising the feature values;
obtaining a second data set comprising the reference feature values; and
applying a comparison to records in the first and second data sets.

17. The system of claim 16, wherein applying the comparison to the first and second data sets comprises:
for each entity key in the set of entity keys, using the entity key to obtain a first record in the first data set and a second record in the second data set; and
comparing a reference feature value of the feature from the first record and a feature value of the feature from the second record.

18. The system of claim 13, wherein comparing the feature values and the reference feature values comprises:
applying a hypothesis test to the feature values and the reference feature values to determine a distribution-level consistency in the feature.

19. The system of claim 13, wherein:
the first environment comprises an offline environment; and
the second environment comprises an online environment.

20. A non-transitory computer-readable storage medium storing instructions that when executed by a computer cause the computer to perform a method, the method comprising:
selecting a set of entity keys associated with reference feature values used with one or more machine learning models, wherein the reference feature values are generated in a first environment;
matching the set of entity keys to feature values from a second environment;
comparing the feature values and the reference feature values to assess a consistency of a feature across the first and second environments; and
outputting a result of the assessed consistency for use in managing the feature in the first and second environments.
